(19) United States
(12) Patent Application Publication
(10) Pub. No.: US 2019/0110409 A1
(43) Pub. Date: Apr. 18, 2019

(54) METHOD FOR LOWERING GLOBAL TEMPERATURE

(71) Applicant: Lianhui ZHOU, Zhangjiagang, Jiangsu (CN)

(72) Inventor: Lianhui ZHOU, Zhangjiagang, Jiangsu (CN)

(21) Appl. No.: 16/093,985

(22) PCT Filed: Jun. 27, 2016
(86) PCT No.: PCT/CN2016/000348

§ 371 Date: Oct. 16, 2018

(30) Foreign Application Priority Data
Apr. 21, 2016 (CN) 201610250213.9

(51) Int. Cl. A01G 15/00; A01G 25/00; E02B 5/00; E02B 13/00

(52) U.S. Cl. CPC A01G 15/00; E02B 13/00; E02B 5/00; A01G 25/00

(57) ABSTRACT

The invention discloses a method for reducing the global temperature, comprising a barge, a belt conveyor and a water pump, characterized in that the following steps are taken: a) transporting a number of empty barges to a region covered with ice floes in the north and south poles, and then using belt conveyor to load the accumulated ice floes into the empty barge; b) drives the barge loaded with ice to the nearest desert country; c) builds more than one reservoir on the desert coast, and a number of artificial canals were built in the sluice of the reservoir; these canals run through the desert to form a hydraulic transport network; d) drain the melted ice water to the reservoir on the coast by gravity or a pump, and open the sluice; ice water flows into the canal, and trees or grass are planted on both banks of the canal.

### TECHNICAL FIELD

The invention belongs to the field of environmental science, in particular to what taking full use of ice floes North and South Pole for afforesting deserts.

### THE ARTS OF BACKGROUND

Desertification is a kind of decline or death of soil yielding, which is caused by strong wind erosion, water erosion and soil salinization etc; at the 1992 World Conference on Environment and Development, desertification has been neatly defined as “land degradation in arid, semi-arid and dry sub-humid regions due to numerous factors including climatic variations and human activities.”

According to the statics by the United Nations Environment Programme (UNEP), the areas that have been affected and expect to be affected by desertification take account for 35% of the global land area, in which Africa accounts for 55%, North and Central America 19%, South America 10%, Asia 34%, Australia 75% and Europe 2%. It sees approximately 60,000-100,000 km² land of desertification in averages across the world each year; in the half of 20^{st} century, the desertified soil in southern Sahara has been enlarged by 650,000 km². The global land size is 162 million km² with 10% desert area, taking account for 30.3% of the entire global area, at same time, 43% of the land size is facing desertification threatening.

In 1953, Peveril Meigs divides the drylands of the Earth into 3 categories:
The extra dryland refers to the terrain (no any vegetation and with annual precipitation less than 100 mm, and without rainfall or periodic rainfall spanning the year), which takes up 4.2% of the global land;
The dryland refers to the terrain where the seasonal grass but not trees grow (the evaporation overtakes the precipitation, which is less than 250 mm), taking up 14.6% of the global land;
The semi-arid land refers to terrain where there has 250-500 mm rainwater and capable of growing grass and scrub.

There is a possibility for reversion and self-recovery of desertification, the odds are affected by different natural conditions, especially water conditions, land surface conditions and the intensity of human activities; only plenty fresh water is supplied, which will reclaim the desert reversion.

Global warming refers to the phenomenon that the atmospheric and oceanic temperature has raised over time in Earth, which is caused either by the large amount of heat from anthropogenic fossil fuel-burning such as crude oil, coal and so forth or by deforesting and burning the timber as of the Industrial Revolution.

Tens of thousands of coal-fired power plants and billions of vehicles across the world are burning and releasing massive thermal energy; especially, after the year 2000, more fossil fuels have been excavated and combusted. As a result, waste and unusable heats are releasing along with large amounts of greenhouse gases, which has engendered frequent outbreaks of extreme weather such as El Ni\ddot{n}o, exacerbating the trend of global warming.

Up-to-date studies have shown that large-scale deforestation, which has reduced forest coverage and aggravated desertification increasingly, is also playing a role of global warming, because green vegetation can absorb photothermal energy, making photosynthesis and dropping down environmental temperature; whereas large areas of deserts increase the land surface temperature, radiating a large amount of solar energy to the surroundings, of course, there are other less important factors to cause global warming apart from these three felons of fossil combustion, deforestation and desertification. Global warming has accelerated melting of ice stored on landmass and melting of glaciers in the Arctic and Antarctic regions, these melting ice waters are emptying themselves into the oceans, giving a rise to sea-level rising. Geological observations show that sea level changes have been negligible during the past 2000 years with an average of only 0.2 mm plus annually; however, the change was about 1.7 mm plus annually in the 20th century of the Post-Industrial Revolution, and since 2010 onwards, it has swung up to 3 mm plus, which not only harms the natural ecosystem, but also threatens the survival of humanity.

They are represented with 4 examples below:

### 1. Water Shortage

The iceberg melted by the rising temperature is the most important source of fresh water; substantial underground freshwater reserves from the melting icebergs are vital to the humanity survival. As the temperature keeps normal balance, the recycling system of the ice and snow of the glaciers will accumulate and filter fresh water for the plain areas, by the way of the glaciers melting down from the mountaintop into the subterraneous layers during summers; whereas, these water, returns to the mountaintops in the form of water vapours during winters by heavy snowfall to amass snow and ice again, which is also a filtrating process. The full recycle process has guaranteed stable and equilibrating fresh water supplies for humanity. Nowadays, the speed of global warming amassing the icebergs and snows is much less than their melting, and even some icebergs has no longer accumulated, which cut off fresh water drinking supplies locally. At the same time, the temperatures in rising will directly absorb water from not only the ocean but also the land, which cause a large areas of inland droughts that triggers off frequent forest and urban conflagration, reducing the grain production as well as the fodder, and food and meat will become scarce, the lack of water also will spark off the conflicts and wars.

### 2. The Natural Food Chains are Gradually Disrupted

The rising of carbon dioxide concentrations in the ocean will carbonate the ocean, killing a large quantities of microorganisms; the oceanic temperatures rising will also destroy a myriad of coral-centered biological chains, in which, the bottommost foods will disappear and quickly disrupt the marine food chain, thereby sprawling beyond the ocean. Because of no food available, a large number of organisms in the ocean will die, contaminating the ocean and accelerating the death of other organisms. The invertebrates, especially insects, will wake up earlier from hibernation, and those long-distance migratory beasts that depend on these insects to prey will be decimated dues to mistiming. These insects awaken in advance will devour large plots of forests and crops with impunity, thanks to natural enemies without

### 3. Humanity Physiological Disorders and Disease Epidemics

Human physiological functions such as spermatozoa activities will abate with temperature going up, various physiological diseases and germs will spread rapidly via extreme weather and climatic events such as El Niño phenomenon and etc., recently the outbreak of the epidemic virus Zika in Brazil has illustrated such an evidence.

### 4. Storms and Superstorms

The heat derived from rising temperatures will provide tremendous kinetic energy to the air and oceans for generating gigantic and ultra-gigantic typhoons, hurricanes, tsunamis, other catastrophes and even superstorms. As the astronomical amounts of melting ice suddenly plumb the temperature of the surface seawater beneath, it will more steepen the oceanic temperature gradients between the tropical and polar zones, slowing down the intermixing between hot and cold ocean currents, and we will experience more violent storms. It can be imagined the temperature gradient as a hill, of which, the higher temperature is on the hillcrest, the lower temperature at the hill foot, as the highness is ascending whereas the lowness is descending, both of which turn the hill cliffier. The storm, like a rolling-down bowl, will gain more speeds on the steeper hillside, if hitting somewhere, it will cause more ruins. Likewise, when these storms full of super-energy are rushing to the coastal cities in mi-latitude, they carry lethal powers. Another study shows even a more astonishing result: when the Arctic ice sheets are melting and adding up rainfalls as well as the types of winds varying, large amounts of fresh water will flow into the North Atlantic, disrupting the Gulf Stream of Mexico and hampering off the North Atlantic warm current, it is these warm currents that transfer those surface warm water from the Caribbean to the northwestern Europe, heating up the European climate. Once the North Atlantic warm currents are warded off because of global warming, the temperature in northwestern Europe shall drop by as much as 5-8° C., and Europe may face a new ice age!

According to the climate model of IPCC (the Intergovernmental Panel on Climate Change), the earth temperatures are predicted to rise about 1.4-5.8° C. by 2100; before the UN Paris Conference in summer 2015, the paper by Hansen with other 16 collaborators has warned that within 50 years, humans are likely to see sea levels rising by at least 10 feet/3 meters. New researches and evidences have confirmed the warnings, presented by the minor meteorologists for many years, that global warming is accelerating in the past, ice from the Arctic Ocean, which will not melt until each June as usual, begin melting in mid-April 2016 ever since.

According to the reports from Associated Press Stockholm on Apr. 14, 2016, the scientific Committee on Climate Change of the United Nations will present one report ad hoc on “how to control the global warming temperature within 1.5° C. in comparison with the Preindustrial Revolution”. After the Paris conference in December 2015, IPCC agreed to discuss this issue in April in response to the governments' requests. Nevertheless many scientists claim that it is almost impossible to achieve such goals without eliminating these huge amounts of endothermic greenhouse gases such as CO² and methane from the atmosphere; the temperatures have risen by 1° C. when humanity began to burn fossil energy since the onset of industrial revolution. Currently, 8.4 billion Mt carbon dioxide is annually emitted into the atmosphere, which raises the contents of carbon dioxide in the atmosphere to an unprecedented level since the dinosaurs had lorded over the earth! In addition, there are nearly 200 billion Mt net losses of ice from Arctic/Greenland glaciers, and about 130 billion Mt net losses of ice from the Antarctic landmass.

“For global warming, people can do three things: to reduce carbon dioxide emissions, to get accustom to the results of these changes or to undertake a large-scale environmental engineering project to resolve the problem fundamentally.” Dr. Kurt Jens House of Harvard University said.

Therefore, scientists from all over the world are positively looking for different methods to absorb carbon dioxide. Dr House presents a plan which is able to absorb more CO₂ by increasing the alkalinity of seawater. The plan details with that: at a special seawater treatment plant, the electric currents are going to pass through the seawater, which will decompose the water and salt, both of them will recombine; as recombining, the volcanic rocks are added for neutralization of the hydrochloric acid, as a result, only the sodium hydroxide is left with the higher ph values of seawater for enhancing the seawater to absorb carbon dioxide. About 100 seawater treatment plants as such can offset 15% of CO₂ emissions in a few years. It is unimaginable shocking that the electrical powers to be consumed by such plan and the impacts on the environment and how to implementing remains an unknown.

Even a more audacious plan is purposed, according to Newsweek on Mar. 22, 2016: “Anders Levermann, a sea level experts at Potsdam Institute for Climate Impact Research come up with the idea that more than 2 inch thickness of seawater shall be pumped and transported via the aerial pipeline to the mesas of the Antarctic glaciers, where these seawaters will be frozen still for a long time, though not forever.” This plan has yet many defects: 1 mm rising of the sea level is equivalent to 360 billion tons seawater, and the current sea level is rising at 3 mm of average annual speed, which, in the future will speed up. In the only one Antarctic continent of Earth without contamination, undertaking such a vast geological project will consume astronomical 7% of the world's energy, and 850,000 wind turbines will be installed in the most inaccessible Antarctic continent (the world's most abundance in wind resources) to produce 1,275 billion watts of electricity (the US's electricity output in 2012 was 106.3 billion watts); at the same time, it will require 90 large pump stations, each of which has capacity of pumping 360 cubic meters of seawater per second. The investment for such project is also unprecedentedly inestimable, in addition to myriads of challengeable questions waiting for our researching, what ecological consequences will engender as loading a huge amount of sea salt water upon the freshwater glaciers has been unknown to us hitherto. Such interventional juggernaut of humanity activities will undoubtedly disrupt the preserved and unique littoral ecosystem of Antarctica, violating the Antarctic Convention.

Other methods include one of these the gushing ashes by artificially inducing volcanic eruptions obscure the sun for a month or more, leaving the earth in nearly full darkness to cooling. The proposal from other British scientists is to capture and collect CO₂ from the atmosphere, and then pump them into the deep ocean. The above methods are not only impractical but also impracticable; if a large amount of CO₂ leaks out in the deep sea, what kinds of environmental aftermaths and ecological disasters will be sparked off are unimaginable, as for activating volcanic eruptions to shield the sun for a certain period of time to contain global warming, it surpass the compass of humanity's burden along with the huge investment beyond imaginations.

One astonishing fact should be paid to enough attention: even based upon the most optimistic speculation that, from now onwards, humans stop emitting greenhouse gases such as CO₂ into the atmosphere, because the massive inertia of global warming, even small glaciers and ice caps melting in the edge of the Greenland and of Antarctic Peninsula, which will also raise the sea level by 50 cm (from Wikipedia), and sure enough inundate dozens of coastal cities and countries such as London, New York, Shanghai, the Netherlands and the Maldives.

Therefore, it is far from enough to stop CO₂ emissions only in 2050 and to transfer all energy consumption modes into green and clean ones, because even humanity bear sea level rising up to merely 20-30 cm, which will drive 740,000 people in Nigeria homeless. We can't wait for dying, more aggressive but harmless climate actions should be taken for saving humanity, by 2100 year ago, from the deep waters and heat weather (sea level rises (flooded coastal cities and large areas of drought).

### SUMMARY OF THE INVENTION

One sound forest ecosystem is capable reducing wind speed by 60-80%, absorbing 35-75% of solar radiation and adding air humidity by 15-20%. Scientists have asserted that if forests disappear from the earth, 90% organisms in the land will be extinct, 90% fresh water of the globe will flow into the sea in vain, biological nitrogen-fixation will be reduced by 90%, biological oxygenation-exhalation will be reduced by 60%, with which, many eco-social problems will be concurrent, and human beings are unable to survive. By photosynthesis, forest inhale CO₂ and exhale oxygen, converting the atmospheric carbon dioxide into carbohydrates and keeping them in the form of biomass, the process of which is named Carbon Sink internationally. Scientific research shows that 1.0 m³ growth of forest is capable of averagely absorb 1.83 Mt CO₂ and release 1.62 Mt oxygen.

Considering all unrealistic or impracticable prior arts for global warming around the world, this inventor has spent 3 years on devising and designing for a practical present invention of how to lower the global warming. As there are hundreds of billion tons of freshwater ice floes produced from the melting glaciers annually in the North and South poles zones, and more than 20 million km² of deserts in the Earth; additionally, there is a fact that the ice in melting process will absorb a certain amount of heat, which will rapidly cool the warming earth. The method goes as that the thawed ice floes from the North and South poles will be loaded into low-cost ice-transporting barges and shipped to the vast desert area, to which, these huge plenty of fresh water are provided for afforesting and absorbing the CO₂ in the atmosphere, synchronically, food and vegetables as well as freshwater fish are farmed for the cash of the deserts yielding.

It is common sense to all of us that desert could only be turn into an oasis unless the soil is in the humid condition, and that humidity should is more than the soil dryness plays a pivotal factor for desertification reversal. Without at guarantee of water resources, all plans on afforesting deserts are mirages. Whereas freshwater resources on the earth are precious and of paucity, it is obviously inadequate to be dependent upon on natural precipitation and man-made rainfalls, which is almost a drop of water in sea for afforesting global deserts thirsty for the huge water consumption.

Tapping groundwater is undoubtedly akin to kill the goose that lays down golden eggs; the seawater desalinations not only need whacking investments but also produce the byproducts of waste water poisonous to the surrounding seawater.

Currently, more than 60,000 km² land areas are desertified every year, at such a speed of development onward to 2100, Australia, Africa and Central Asia may be all degenerated into deserts unsuitable for people survival, suffering the same curse as the ancient civilization of Loulan/Krorän Kingdom buried in the dunes. If humanity refuses to take positive actions against this huge global climate crisis, the tragic history will repeat itself; only braving the challenges from the environment, taking advantages of nature rule in awe and full use of humanity wisdoms, the deteriorating natural environment shall be reversed. The economic system based upon fossil energy is teeming loopholes and should be completely abandoned, but rather, which, like dying cancerous body, has been ridiculously running by the so-called stupid high-tech, such as shale gas developed in some developed countries.

The most common trees suitable for desert growth will be exemplified by the below ones: Populus euphratica, alternatively known as Euphrates poplar, early grew near the Mediterranean Sea and is suitable for the Sahara and some Asian and African deserts. With its endurance to not only the fickle and drought desert climate but also to saline and alkali in particular, the roots of Euphrates poplar ably penetrate into the soil surface 20 meters below for absorbing groundwater and storing a large amount of water into its trunk, the alkaloids of which can be made into soap or for tanning in addition to edible, the leaves of which can be used as fodder, the wood of which, resistant to water and corrosion, is a special material for building bridge and for paper making and furniture making too. Euphrates poplar, if supplying sufficient water, can grow as fast as up to 0.005 m³/m² per year. Eucalyptus, as the fastest-growing tree species in the world and a good material for papermaking, can generally develop 0.01 m³/m² per year; with 3.4 million km² areas of desert and semi-desert, Australia is ideal to the growth of eucalyptus.

If 100,000 km² areas of Euphrates poplar and eucalyptus are planted for carbon offset in the Sahara and Australian deserts each year.

1.0 m³ growth per forest can absorb 1.83 Mt CO₂ and release 1.62 Mt oxygen in average; 1 m² areas of Euphrates poplar will grow 0.005 m³ each year, which will absorb

0.005m³*1.83Mt=0.00915 tons(CO₂)m³.

The following calculation will be obtained as a result:

Planting 100,000 km²(10¹⁴ m²) areas of Euphrates poplar in the Sahara Desert per year will absorb below amount of CO₂:

100,000 km² areas of which will absorb:

100,000*1 million*0.00915(tons)=9.15*100*1 million(tons)=0.915 billion tons;

Similarly, 100,000 km² area of eucalyptus in Australia can absorb the amount of CO₂:

(0.01/0.005)×9.15 billion Mt=1.83 billion tons

Both of which are totaled to 2.7 billion tons, equivalent of one-third of the world's 8 billion Mt CO₂ emissions per year. With only 3-5 years continuity of growing, the CO₂ of the northern and southern hemispheres will be completely absorbed and off-set.

How much water is needed for afforesting 200,000 km² of seedling? According to the annual rainfall of 500 mm (0.5 Mt) per m², the annual fresh water for planting 200,000 km² of poplar eucalyptus will get below result:

200,000 * million square meters * 0.5 tons/square meter, that is 100 billion tons.

The above calculation may have a certain error, but within the range of approximately 10%.

According to statistics since 2003, Greenland has lost an average of 210 billion Mt of ice per year, while the western Antarctic has lost 130 billion Mt of ice per year, whereas the eastern Antarctic has gained 80 billion Mt of ice per year. Therefore, there is more than enough water for humanity's afforesting the deserts. Apart from that, these ice melted in the deserts have astonishing potentialities to absorb CO² from the atmosphere. At the same time, when a huge amount of 100 billion Mt of ice below a few degrees than minus 0° C. melts into 30° C. water in the deserts, the amount of heat absorbing from surroundings will be gigantic, which will lower the temperature of northern and southern hemisphere; as for as the accurate figure as such, it requires emulational computing due to difference from the specific heat of ice in physics.

Subsequently, does this huge project also need astronomical investment? According to the loading 100,000 Mt of ice for each barge, 50 times per year (either plying from Australia to the South Pole or from the Arctic to the northern Sahara), each barge can carry 5 million Mt of ice floes, as result, 100 billion Mt of fresh water per annum will need around 20,000 barges, which make the cost of each barge very important; as to this, the inventor has deliberately designed one kind of fast-building and low-cost barge to carry ice, the cost of which spends less than 10 million US dollars and less than 3 months for its completion. Eventually, the investment in aggregate will not exceed 1 trillion US dollars, including 200 billion US dollars for 20,000 barges as well as other miscellaneous disbursement added.

The power to drive the barge will use prior arts such as cold nuclear fusion or electromagnetic power, rather than the diesel or heavy oil contaminating the ocean; each load will ship 100,000 Mt of the ice floes, which costs less than $200,000, the equivalent of less than $2 for each ton of fresh water. If the sea level rises by 0.5 meters in the 2050 s, hundreds of cities around the world will be inundated, making the loss of trillions dollars. The implementation of this method will provides a large number of employment opportunities for developing countries and valuable fresh water to water-shortage countries, increasing the total production of food, vegetables, fruits and fisheries in desert areas, depressurize overpopulation. At the same time, this method will bring healthy benefit to the entire Earth ecosystem without or scantily malignant side-effects.

### DESCRIPTION

The method is described as below:

A method for lowering global temperature, which comprises barges, belt conveyors, and water pumps, wherein the following steps are taken: a plurality of wind-power farms will be built in the Polar Regions in which are abound with plenty of ice floes. At the same time, a plurality of quays will be constructed with a plurality of belt conveyors installed nearby; each belt conveyor has the capacity for transferring ice rocks not less than 1000 Mt per hour. More than one seaport to be designed on the seashores of desert areas nearest to the Antarctic or the Arctic Greenland will be built with a reservoir in the proximity of the seaport; the reservoir capable holding at least 1 million m³ of water will be provided plus at least one sluice being built at its outlets, to which, a plurality artificial canals are built as a waterborne network to criss-cross the desert, said artificial canals are composed of arterial and ramification canals, wherein the arterial canals are navigable for a ship of at least 1000 Mt load, and the ramification canals a ship of at least 100 Mt load.

a plurality of empty-loaded barges are shipped to the Arctic and Antarctic regions which are full of ice floes, after said empty-loaded barges are loaded with the collected ice floes by belt conveyors, they will sail to the nearest the desert seaports as the Antarctic one to Australia and the Arctic one to Sarah, for example.

the melted ice water are drain to said reservoir on the seashore by its own gravity or pump, and the sluice are opened for the ice water flowing into the canals, upon both embankments of which, seedlings or grass suitable for the deserts will be grown, the eucalyptus is preferred to Australian desert whereas the Euphrates poplar to the Sahara desert.

Each barge carries a minimum load of 100,000 Mt ice, and the annual amount of ice floe to be shipped by the barges are not less than 100 billion tons, of which, no less than 40 billion Mt comes out of Antarctic region and no less than 60 billion Mt out of Arctic region. The seedlings to be planted each year in the northern and southern hemispheres will not be less than 200,000 km², preferably 100,000 km² for Australia and 100,000 km² for the northern Sahara.

### The Embodiment 1

Embodiment 1 is taken the Australian desert as an example.

First, in Antarctic region, a number of areas congregate with ice floes will be chosen as ice quarrying sites, in which pluralities of conveyor belts will be installed. The power driving the conveyor belts will comes from wind power generator as rich wind resources in the North and South poles regions are able to meet hundreds of wind turbines construction there.

The cracked ice floes floating around the edge of the Antarctic landmass will be towed by fishing nets towards and collectively stacked upon the ice-quarrying sites, each of which will be built with quays for wharfing large ice-carrying barges. The stacked-upon ice floes will be loaded on the ice-carrying barges by the conveyor belts. As soon as they are full-loaded, the barges will ship to the seashore ports of the Australian Desert nearest the Antarctic landmass. The robots will be employed for the most operation against the hard and harsh wintry weathers.

The preferable embodiment is exemplified below: in the seashores of said desert countries/areas are provided with more than one reservoir on the topographical pinnacle, also at least one sluice being built at the reservoir outlet, to which, a plurality artificial canals nearby the deserts are built as a waterborne networks to criss-cross the desert; furthermore, said artificial canals are composed of arterial and ramification canals, wherein the arterial canals are navigable for a ship of at least 1000 Mt load, and the ramification canals a ship of at least 100 Mt load.

Since most of the desert areas are very hot with the average temperature 30° C. plus, the ice from the dipolar regions will soon melt once delivered to the desert seashore ports, which will absorb plenty heat and lower the desert high temperature. The melting ice water will be, by either its own gravity or the water pumps, drained to the reservoir on the seashore. When the waterhead of the ice water in the reservoir are accumulated enough and discharged into the canal via the unlocked sluice, they will augment the quantities of the water reserved on both embankments of the canal for indigenous trees such as eucalyptus or Euphrates poplar.

The hack of infrastructure in the desert hinterlands makes the logistics of the conventional railway and highway unrealistic for afforesting deserts, even if feasible, the investment is not only substantially huge, but there is a prolific, potential risks of the built-up railways and highways will be buried by the drifting sand dunes within a few years.

Therefore, the logistic in the desert shall be principal plied by the water transportation between the artificial canals. There is no relocation cost for residents in desert areas thanks to their nearly uninhabited. Beside the huge amount of ice water play a cheap navigation role for these canals, their evaporation can significantly ameliorate the microclimate in the both embankments and surroundings. The water seeping into the vicinity of the canal embankments, will not only replenish increasingly depleted groundwater resources, but keep stable supplies for rapid growing of the vegetation of eucalyptus and Euphrates poplar on the embankment, and the root system of these vegetation will gradually fix the drilling sand dunes, improving the desert structure. The canal in desert areas is a protective lifeline of water for the nearby precinct residents and new immigrant workers to live and work like reforesting and growing fruits and vegetables. In addition, at sonic nodes of the canal, a plurality of large artificial lakes can be built for desert-sightseeing and aquaculture as a cash cow.

### Embodiment 2

The same method as in embodiment 1 will be carried out, except that the ice floes are shipped from the Arctic/Greenland to the Sahara Desert in the northern hemisphere, and the seedlings to be planted are Euphrates populars.

The beneficial effects or the invention are:

the large amount of melting ice will rapidly lower global temperatures by absorbing large amount of heat in the arid desert, and shipping 100 billion Mt per annum can reduce sea level by 0.3 mm, in avoidance of drastic fluctuation in ocean temperature gradients and the consequent superstorms.

Plenty and pure fresh water is provided for the deserts lack of rainfalls. If the 0.5 m thickness water per m² is annually supplied for afforesting, the 100 billion Mt shipping will afforest 200,000 km² desert, and 10 million km² for consecutive 50 years. Plenty evaporated fresh water can completely transform the arid desert climate; in combination with green vegetation absorbing a large amount of CO₂. 8 billion Mt CO₂ emission per year will be absorbed completely within 5 years. The afforested desert will be colonized by hundreds of millions of people, which will alleviate the land and environmental pressures due to overpopulation, creating a myriad job opportunities.

Finally, the impact of such projects on the Arctic and the Antarctic environment is assessed: what the ice-carrying barges collect and convey are the ice that has already melted or is in imminent melting, it will not disrupt the balance of the water circulation in the north and south poles without side-effects; furthermore, the power to drive the ice-carrying barges can use clean energy such as magneto-dynamic or cold fusion, avoiding the conventional exhausting heat and greenhouse gas emissions from the prior art of petrochemical energy, such the impact of pollution on the ocean is negligible. At the same time, the popular employment of drones and intelligent robots will replace manual operations, reducing the most of pollution caused by overstaff on the Polar Regions, e.g. 20,000 barges will just need 100,000 people with an average of 5 crews onboard each.

the electrical power demanding for the belt conveyor is calculated as below, given the 1000 Mt ice per hour is processed (300 days per year) for the annual 100 billion Mt ice floes transferring, the number of belt conveyors:

100 billion tons=1000*10000*10000Mt

1000*10000*10000Mt/(300*24*1000Mt)

=10000*10000/300*24

=10000*100/3*24=14000 units.

The north and south poles need 7,000 belt conveyors respectively. The power for each belt conveyor is 40 kw. The rating power per wind turbines is 2000 kw, which translate that 7000 * 40 kw/2000 kw, i.e. 140 sets, which, in the either pole, can fully meet the power demanding for ice loading, unloading and conveying.

The forestation, irrigation and drainage and waterhead elevated sun-drenched desert area can be all done by the installed solar photovoltaic power, the latest technology will be reduce the cost of that to U$ 120/KW by 2019.

When the earth temperature returns to a normal historical level, ice transportation as such will by and large come to stop; however it must be conceded that exerting this effective plan shall not be disguised as an excuse for humanity to procrastinate a rapid reincarnation from the suicidal development model based-on fossil energy into the sustainable development one based-on pollution-free energy. For deserted area far from the seashore, the vacuum pipe can be used to transmit the ice water into the artificial canals of the desert for afforesting.

The above-mentioned ones are just preferred embodiments of this present invention, by which and without deviating from the principle of which, a plurality of modifications and variations can be made by the person skilled in the art, such modifications and variations should be also within the scope of protection meted by the claims of this invention.

1. A method for lowering global temperature, comprising barges, belt conveyors, and water pumps, wherein the following steps:
a) a plurality of empty-loaded barges are shipped to the Arctic and Antarctic regions where ice floes are full of, said empty-loaded barges are loaded with the collected ice floes by belt conveyors;
b) the barges full-loaded of ice will sail to the nearest the desert country/area
C) on the seashores of said desert country/area, more than one reservoir is built with at least one sluice devised at its outlets, to which, a plurality artificial canals are built as a waterborne network to criss-cross the desert;
d) the melted ice water, by its own gravity or water pump, is discharged to said reservoir on the seashore, and the sluice are simultaneously unlocked for the ice water flowing into the both embankments of canals for growing seedlings or grass.

2. The method of claim 1, wherein, said barge has the minimum load of 100,000 Mt.

3. The method of claim 1, wherein, the annual amount of ice floes to be shipped by the barges are not less than 100 billion Mt.

4. The method of claim 1, wherein, said reservoir is preferably located on the topographical pinnacle of said desert seashore.

5. The method of claim 1, wherein, said artificial canals are composed of arterial ones navigable for a ship of minimum 1000 Mt load and the ramification ones navigable for a ship of minimum 100 Mt load.

6. The method of claim 1, wherein, the barges loaded with ice in the Antarctic region are bound for the seashore in Australian deserts, whereas the barges loaded with ice in the Arctic region for the seashore of the Sahara deserts.

7. The method of claim 1, wherein, the desert areas to be afforested are not less than 200,000 km², preferably 100,000 km² in Australia and 100,000 km² in the northern Sahara.
